(19) United States
(12) Patent Application Publication
(10) Pub. No.: US 2014/0335385 A1
(43) Pub. Date: Nov. 13, 2014

(54) BUS BAR MODULES

(71) Applicants: AISAN KOGYO KABUSHIKI KAISHA, Obu-shi (JP); TOYOTA JIDOSHA KABUSHIKI KAISHA, Toyota-shi (JP)

(72) Inventors: Masaki IKEYA, Obu-shi (JP); Norio NISHIWAKI, Tajimi-shi (JP); Yasuharu TERADA, Toyota-shi (JP)

(73) Assignees: TOYOTA JIDOSHA KABUSHIKI KAISHA, Toyota-shi (JP); AISAN KOGYO KABUSHIKI KAISHA, Obu-shi (JP)

(21) Appl. No.: 14/269,991

(22) Filed: May 5, 2014

(30) Foreign Application Priority Data
May 9, 2013 (JP) 2013-099430

(51) Int. Cl. H01M 2/20; H01M 2/12

(52) U.S. Cl. CPC H01M 2/206; H01M 2/1252
USPC 429/53; 429/121

(57) ABSTRACT

A bus bar module may have a bus bar including a battery side terminal portion and a connection portion. The battery side terminal portion may electrically connect electrode terminals of two adjacent battery cells of a battery assembly. The connection portion may electrically connect the battery side terminal portion and a terminal of a circuit side member associated with the battery assembly. The bus bar may be configured as a single member.

This application claims priority to Japanese patent application serial number 2013-99430, filed on May 9, 2013, the contents of which are incorporated herein by reference in their entirety for all purposes.

### BACKGROUND

Embodiments of the present disclosure mainly relate to bus bar modules of battery assemblies. The battery assembly may be used as a power source device mounted to a vehicle such as a hybrid car traveling by the drive force of an engine (internal combustion engine) and the drive force of an electric motor. Such a battery assembly may also be used by an electric automobile traveling by the drive force of an electric motor.

A bus bar module of this type is disclosed, for example, in JP-A-2012-64555. The bus bar module disclosed in this document is equipped with a circuit side member associated with a battery assembly having a plurality of battery cells arranged adjacent to each other in an arrangement direction, a battery side terminal connecting the electrode terminals of adjacent battery cells of the battery assembly, a connection line connecting the battery side terminal and a terminal of the circuit side member, and a resin member for providing insulation between the battery side terminal and the connection line. Formed on the connection line is a displacement absorption portion configured to absorb the displacement of the battery side terminal when the battery assembly expands and contracts in the arrangement direction.

In JP-A-2012-64555 noted above, the connection line, which is formed separately from the battery side terminal, is connected to the battery side terminal and the terminal of the circuit side member. This configuration results in an increase in the number of components and assembling steps.

Therefore, there has been a need in the art for a bus module helping to achieve a reduction in the number of components and assembly steps.

### BRIEF SUMMARY OF THE DISCLOSURE

In one aspect according to the present teachings, a bus bar module may include a bus bar having a battery side terminal portion and a connection portion. The battery side terminal portion may electrically connect the electrode terminals of two adjacent battery cells of a battery assembly. The connection portion may electrically connect the battery side terminal portion and a terminal of a circuit side member associated with the battery assembly. The bus bar may be configured as a single member.

### BRIEF DESCRIPTION OF THE DRAWINGS

FIG. 1 is a schematic front view of a battery module according to a first embodiment;

FIG. 2 is a schematic front view of a bus bar module of the battery module;

FIG. 3 is a schematic side view of the bus bar module;

FIG. 4 is a schematic plan view of the bus bar module;

FIG. 5 is a schematic view of a gas discharge duct of the battery module;

FIG. 6 is a schematic side sectional view of the gas discharge duct;

FIG. 7 is a sectional view taken along line VII-VII in FIG. 6;

FIG. 8 is a schematic plan view of a primary intermediate forming product of the bus bar module;

FIG. 9 is a schematic plan view of a secondary intermediate forming product of the bus bar module;

FIG. 10 is a schematic front view of the secondary intermediate forming product;

FIG. 11 is a schematic side view of the secondary intermediate forming product;

FIG. 12 is a schematic perspective view of the secondary intermediate forming product;

FIG. 13 is a schematic plan view of the peripheral portion of a battery side terminal portion of a bus bar module according to another embodiment;

FIG. 14 is a schematic plan view of a primary intermediate forming product of a bus bar module according to another embodiment;

FIG. 15 is a schematic plan view of a secondary intermediate forming product of the bus bar module according to the embodiment of FIG. 14;

FIG. 16 is a schematic front view of the secondary intermediate forming product;

FIG. 17 is a schematic front view of a bus bar module according to another embodiment;

FIG. 18 is a schematic plan view of the bus bar module shown in FIG. 17;

FIG. 19 is a schematic front view of a bus bar module according to another embodiment;

FIG. 20 is a schematic front view of a bus bar module according to another embodiment;

FIG. 21 is a schematic front view of a bus bar module according to another embodiment;

FIG. 22 is a schematic front view of a bus bar module according to another embodiment;

FIG. 23 is a sectional view taken along line XXIII-XXIII in FIG. 22;

FIG. 24 is a schematic front view of a bus bar module according to another embodiment;

FIG. 25 is a schematic plan view of a gas discharge duct according to another embodiment;

FIG. 26 is a schematic front sectional view of the gas discharge duct shown in FIG. 25;

FIG. 27 is a schematic plan view of a gas discharge duct according to another embodiment;

FIG. 28 is a schematic front sectional view of the gas discharge duct shown in FIG. 27;

FIG. 29 is a schematic front sectional view of a gas discharge duct according to another embodiment;

FIG. 30 is a schematic plan view of a gas discharge duct according to another embodiment;

FIG. 31 is a sectional view taken along line XXXI-XXXI in FIG. 30;

FIG. 32 is a sectional view taken along line XXXII-XXXII in FIG. 31;

FIG. 33 is a schematic plan view of a gas discharge duct according to another embodiment;

FIG. 34 is a sectional view taken along line XXXIV-XXXIV in FIG. 33;

FIG. 35 is a sectional view taken along line XXXV-XXXV in FIG. 34;

FIG. 36 is a schematic plan view of a gas discharge duct according to another embodiment;

FIG. 37 is a sectional view taken along line XXXVII-XXXVII in FIG. 36;

FIG. 38 is a sectional view taken along line XXXVIII-XXXVIII in FIG. 37;

FIG. 39 is a schematic plan view of a gas discharge duct according to another embodiment;

FIG. 40 is a sectional view taken along line XL-XL in FIG. 39;

FIG. 41 is a sectional view taken along line XLI-XLI in FIG. 40;

FIG. 42 is a schematic plan view of a gas discharge duct according to another embodiment;

FIG. 43 is a sectional view taken along line XLIII-XLIII in FIG. 42;

FIG. 44 is a sectional view taken along line XLIV-XLIV in FIG. 43;

FIG. 45 is a schematic front sectional view of a gas discharge duct according to another embodiment; and

FIG. 46 is a schematic front sectional view of a gas discharge duct according to another embodiment.

### DETAILED DESCRIPTION

In one embodiment, a bus bar module may include a circuit side member, a bus bar and a resin member. The circuit side member may be associated with a battery assembly having a plurality of battery cells arranged next to each other in an arrangement direction. The bus bar may include a battery side terminal portion and a connection portion. The battery side terminal portion may electrically connect the electrode terminals of two adjacent battery cells of the battery assembly. The connection portion may electrically connect the battery side terminal portion and a terminal of the circuit side member. The resin member may insulate the bus bar. The bus bar may be configured as a single member. The connection portion of the bus bar may be formed with a displacement absorbing portion capable of absorbing displacement of the battery side terminal portion caused by the expansion or contraction in the arrangement direction of the battery assembly.

With this arrangement, the bus bar module having the battery side terminal portion and the connection portion is formed as a single member, so that it is possible to achieve a reduction in the number of components and the number of steps in assembling the bus bar. As a result, it is possible to achieve a reduction in the number of components and in the number of steps in assembling the bus bar module.

In addition, the displacement absorption portion may absorb any displacement of the battery side terminal portions caused by the expansion and contraction in the arrangement direction of the battery assembly. Therefore, it is possible to absorb the change in the dimension in the arrangement direction of the battery assembly, which may be caused due to changes in temperature during use of the bus bar module and due to charging/discharging. As a result, it is possible to prevent the circuit side member from being affected by the dimensional changes in the arrangement direction of the battery assembly. Consequently, it is not necessary to form the circuit side member such that it can expand or contract by taking into account the expansion and contraction in the arrangement direction of the battery assembly. Therefore, it is possible to achieve an improvement in terms of the degree of freedom in the design of the circuit side member, and to achieve a reduction in the size of the circuit side member. Further, it is possible to easily produce the circuit side member in a fixed dimension.

Furthermore, it is possible to absorb any dimensional difference in the arrangement direction of the battery assembly which may be caused due to individual variation of the battery cells of the battery assembly at the time of assembly of the bus bar module.

The displacement absorbing portion of the bus bar may have a strip shape and may be elastically deformable in a direction of its thickness thereof. With this construction, it is possible to suppress elastic deformation in a direction other than the thickness direction of the connection portion while allowing elastic deformation in the thickness direction of the connection portion of the bus bar.

The bus bar module may comprise a plurality of bus bars, and the resin member may include a plurality of resin portions respectively covering the battery side terminal portions of the bus bars. A restriction device may be provided between two adjacent resin portions and may be configured to restrict relative movement of the battery assembly in a width direction.

With this arrangement, it is possible to achieve an improvement in terms of the assembling property of the battery side terminal portions of the bus bars with the electrode terminals of the battery cells of the battery assembly.

In another embodiment, a bus bar module may include a circuit side member associated with a battery assembly having a plurality of battery cells lying adjacent to each other, and a bus bar having a battery side terminal portion and a connection portion. The battery side terminal portion may electrically connect the electrode terminals of two adjacent battery cells of the battery assembly. The connection portion may electrically connect the battery side terminal portion and a terminal of the circuit side member. The bus bar may be a single member where the battery side terminal portion and the connection portion are integrated with each other.

In a further embodiment, a bus bar module may include a circuit side member associated with a battery assembly having a plurality of battery cells arranged adjacent to each other, and a bus bar having a battery side terminal portion and a connection portion connected to each other. The battery side terminal portion may electrically connect the electrode terminals of two adjacent battery cells of the battery assembly. The connection portion may electrically connect the battery side terminal portion and a terminal of the circuit side member. The connection portion of the bus bar may be formed with a displacement absorbing portion capable of absorbing displacement of the battery side terminal portion caused by expansion or contraction in the arrangement direction of the battery assembly.

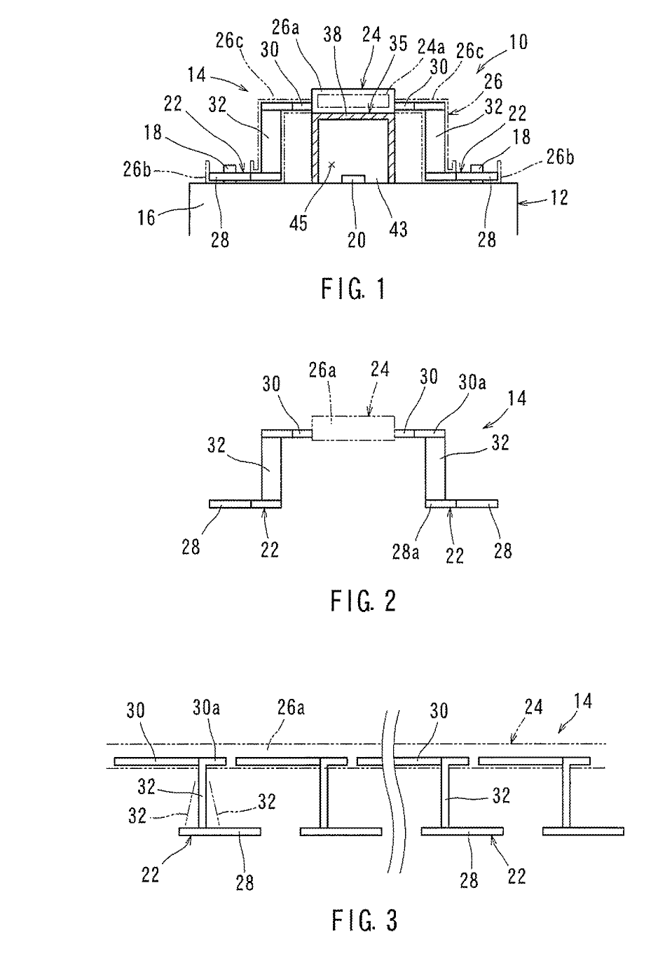

An embodiment will now be described with reference to FIGS. 1 through 12. In this embodiment, a battery module used as a power source device for a hybrid car will be described. FIG. 1 is a front view schematically illustrating the battery module according to the current embodiment. For the purpose of illustration, an arrangement direction (a direction perpendicular to the sheet of FIG. 1) of a battery assembly of the battery module will be referred to as a front and rear directions, and a direction crossing the arrangement direction (i.e., a right and left direction) will be referred to as a width direction. As shown in FIG. 1, a battery module 10 is equipped with a battery assembly 12 and a bus bar module 14.

The battery assembly 12 may be provided with a plurality of battery cells 16 (of which one is shown in FIG. 1) arranged next to each other in the front and rear directions (the direction perpendicular to the sheet of FIG. 1), i.e., in the arrangement direction. Each battery cell 16 may have a rectangular parallelepiped shape having a relatively large width in the right and left direction and a relatively small height in the front and rear directions. A pair of electrode terminals 18 may protrude from the right and left end portions of the upper surface of each battery cell 16. One of the pair of electrode terminals 18 is a positive side electrode terminal, and the other is a negative side electrode terminal. Two battery cells 16 positioned adjacent to each other in the front and rear directions are arranged such that the poles of the electrode terminals 18 are opposite each other. A safety valve 20 may be provided at the center of the upper surface of the battery cell 16. When the internal pressure of the battery cells 16 reaches an abnormal level, the safety valve 20 may open for discharging (ejecting) the gas in the battery cells 16 upwardly via a gas discharge port (not shown). Lithium ion battery cells may be used as the battery cells 16. Further, the plurality of battery cells 16 may be integrally retained by a retaining member such as a frame or a casing (not shown).

The bus bar module 14 is arranged on the battery assembly 12. The bus bar module 14 may include a plurality of bus bars 22, a circuit side member 24, and a resin member 26. The resin member 26 may be integrated with the bus bars 22 and the circuit side member 24 through insert molding. The resin member 26 may also serve to insulate and cover the bus bars 22. The resin member 26 may be made of a resin material having an insulative property and flexibility.

The circuit side member 24 may include an electrical component 24a that is associated with the battery assembly 12 and is covered with the resin member 26. Of the resin member 26, a portion covering the circuit side member 24 will be hereinafter referred to as a resin portion 26a. The electrical component 24a may be at least one of the following: an electrical component or the like for monitoring and controlling the condition of the battery cells 16, wiring such as a signal line or a connection line related to the wiring of the electrical components, or a printed circuit board on which other electrical components or the like are mounted. The circuit side member 24 is formed as an elongated member of a laterally elongated rectangular sectional configuration and extending in the front and rear directions (the directions perpendicular to the sheet of FIG. 1). Further, the circuit side member 24 is arranged above the battery assembly 12 so as to be spaced therefrom by a predetermined distance.

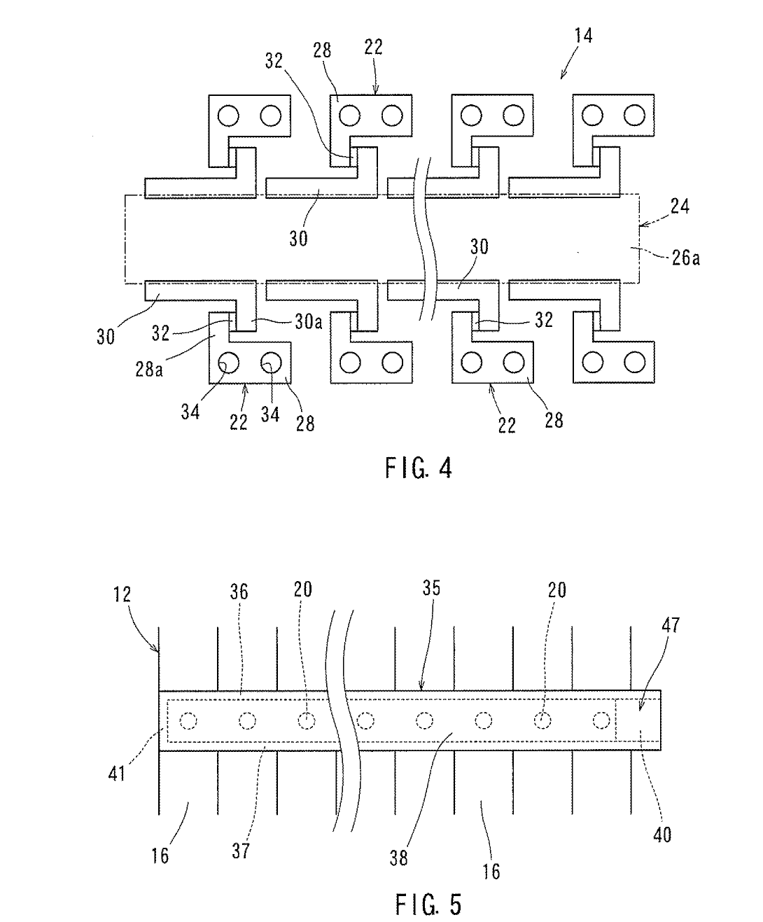

The bus bars 22 may be electrically conductive members which effect connection between the positive side electrode terminals 18 and the negative pole side electrode terminals 18 of the battery assembly 12 arranged adjacent each other in the front and rear directions. The bus bars 22 provide for a connection between the electrode terminals 18 and the terminal (not shown) of the circuit side member 24. FIG. 2 is a front view schematically illustrating the bus bar module 14; FIG. 3 is a side view of the same; and FIG. 4 is a plan view of the same. In FIGS. 2 through 4, the resin member 26 covering the bus bars 22 is omitted.

As shown in FIGS. 2 and 3, each bus bar 22 may include a battery side terminal portion 28, a circuit side terminal portion 30 and a connection portion 32 that are integrated with each other. The connection portion 32 may connect the two terminal portions 28 and 30. Each bus bar 22 may be formed by press-molding a conductive metal plate. An example of the molding process of the bus bar 22 will be described below.

As shown in FIG. 4, the battery side terminal portions 28 may be formed as strip-like plates elongated in the front and rear directions (the right and left direction in FIG. 4). The thickness direction of the battery side terminal portions 28 may be oriented in the vertical direction (the direction perpendicular to the sheet of FIG. 4). Each battery side terminal portion 28 may have a pair of front and rear mounting holes 34. Both mounting holes 34 are capable of being fitted with the electrode terminals 18 of two battery cells 16 arranged adjacent to each other in the front and rear directions (see FIG. 1).

The circuit side terminal portions 30 may be formed as strip-like plates elongated in the front and rear directions. The thickness direction of the circuit side terminal portions 30 may be oriented in the vertical direction (the direction perpendicular to the sheet of FIG. 4). In a plan view of the bus bars 22, protrusions 28a and 30a are formed at the opposing edges of the battery side terminal portions 28 and the circuit side terminal portions 30. Further, within the resin portion 26a, the circuit side terminal portions 30 are connected to the terminals (not shown) of the circuit side member 24. Regarding the resin member 26 (see FIG. 1), a portion covering the battery side terminal portions 28 will be hereinafter referred to as a resin portion 26b. A portion covering the connection portion 32 and the edge portion of the circuit side terminal portion 30 on the side of the protrusion 30a will be hereinafter referred to as a resin portion 26c.

As shown in FIG. 2, the connection portions 32 connect the protrusions 28a of the battery side terminal portions 28 and the protrusions 30a of the circuit side terminal portions 30. The connection portions 32 are formed as strip-like plates extending in the vertical direction (the height direction). The thickness direction of the connection portions 32 is oriented in the front and rear directions (the direction perpendicular to the sheet of FIG. 2). The connection portions 32 are formed so as to be capable of elastic deformation or so-called deflection deformation in the thickness direction, i.e., the front and rear directions (see the chain double-dashed lines in FIG. 3 showing potential deflections for connection portions 32). As a result of the deflection deformation of the connection portions 32, it may be possible to absorb displacement of the battery side terminal portions 28 caused by the expansion and contraction in the arrangement direction (the direction perpendicular to the sheet of FIG. 1) of the battery assembly 12 (see FIG. 1). That is, the connection portions 32 also serve as displacement absorption portions. Further, the connection portions 32 also serve as support leg portions supporting the circuit side member 24. “Elastic deformation” refers not only the deflection deformation in the bending direction but also to deflection deformation in the twisting direction.

As shown in FIG. 1, the circuit side member 24 of the bus bar module 14 may be provided with a gas discharge duct 35 for the flow of the gas discharged from the safety valve 20 of each battery cell 16. In FIG. 1, the gas discharge duct 35 is shown in a sectional view.

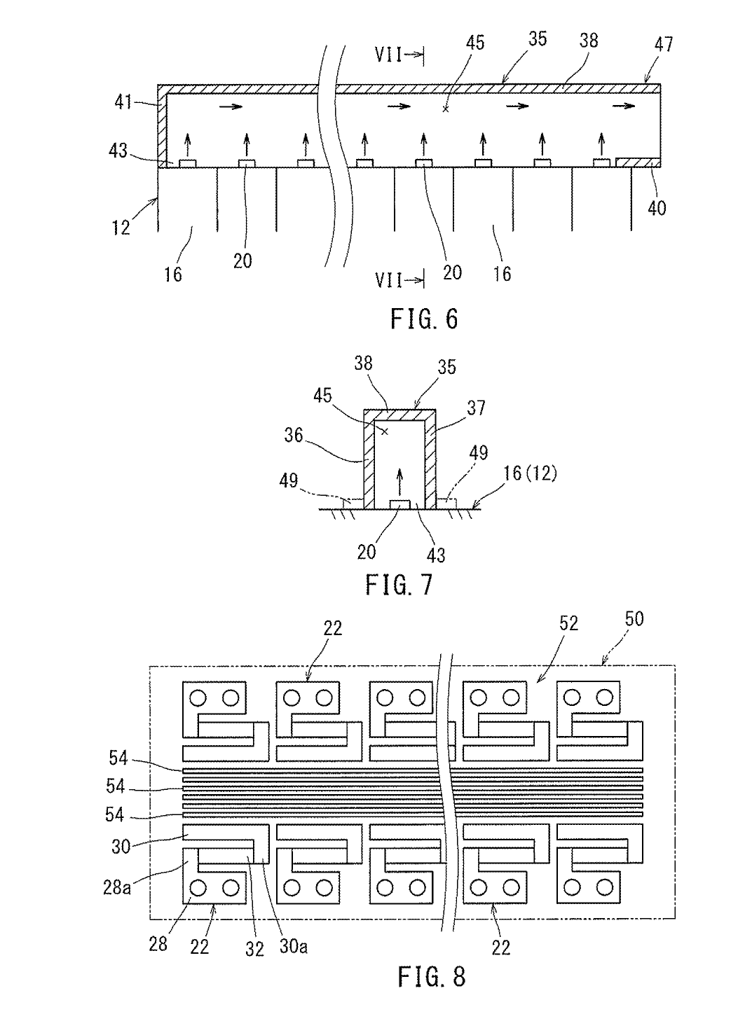

As shown in FIGS. 5 and 6, the gas discharge duct 35 may be made of resin and may have an elongated configuration extending in the front and rear directions (the right and left direction in FIGS. 5 and 6). As shown in FIG. 7, the gas discharge duct 35 may be formed as a rectangular tube having a left-hand side wall 36, a right-hand side wall 37, an upper wall 38, and a lower wall 40 (see FIG. 6). As shown in FIG. 6, the front end (the left-hand end surface in FIG. 6) of the gas discharge duct 35 may be closed by a front wall 41. The lower wall 40 is only formed at the rear end portion of the discharge duct 35, and a gas introduction port 43 is open at the lower surface side of the gas discharge duct 35. The interior of the gas discharge duct 35 may serve as a gas path 45. The rear end portion (the right-hand end portion in FIG. 6) of the gas discharge duct 35, that is, the tubular portion, may constitute a connection port 47 to which a gas discharge conduit line (not shown) communicating with the exterior of the vehicle may be connected. The gas discharge conduit line communicates with the exterior of the vehicle.

The gas discharge duct 35 may be made of a hard resin material exhibiting heat resistance. Further, as shown in FIG. 1, the gas discharge duct 35 may be arranged on the lower surface side of the circuit side member 24. The upper wall 38 of the gas discharge duct 35 may be integrally connected to the lower surface side of the resin portion 26a of the circuit side member 24 by a suitable connection means. Such connection means may include: adhesive, fusion-bonding, snap-fitting, or fastening. The gas introduction port 43 may be partially open in the lower wall 40. The introduction port 43 may be formed as holes respectively corresponding to the safety valves 20; or it may be formed as holes corresponding to two adjacent safety valves 20. Further, as shown in FIG. 7, a flange 49 extending in the longitudinal direction (the direction perpendicular to the sheet of FIG. 7) may be formed on the outer side of the left-hand side wall 36 and/or the right-hand side wall 37.

Next, a method for arranging the bus bar module 14 and the battery assembly 12 will be described. First, as shown in FIG. 1, the bus bar module 14 may be placed on the battery assembly 12. Then, the mounting holes 34 (see FIG. 4) of the battery side terminal portions 28 of the bus bars 22 are fitted with electrode terminals 18 from the adjacent battery cells 16. Nuts (not shown) are fastened to the electrode terminals 18 whereby the battery side terminal portions 28 are fastened to the electrode terminals 18. At the same time, the lower surface of the gas discharge duct 35 is brought into contact with or in proximity to the upper surface of the battery assembly 12. The gas introduction port 43 of the gas discharge duct 35 may be positioned to oppose the safety valves 20 of the battery cells 16 of the battery assembly 12. In this way, the battery module 10 (See FIG. 1) can be formed.

The battery module 10 (see FIG. 1) may be mounted in a vehicle (not shown). Electrical wiring connected to an electric circuit having an electric motor (not shown), electrical wiring connected to an electric circuit having a controller, etc. may be connected to the circuit side member 24. Further, a gas discharge conduit line (not shown) communicating with the exterior of the vehicle may be connected to the connection port 47 (see FIG. 6) of the gas discharge duct 35. The gas discharged from the safety valves 20 of the battery cells 16 may flow rearwards through the gas path 45 of the gas discharge duct 35 before being discharged to the exterior of the vehicle. It is discharged from the connection port 47 (see FIG. 6) via the gas discharge conduit line. In FIGS. 6 and 7, arrows indicate the flow of gas.

An example of the molding process of the bus bars 22 will now be described. As shown in FIG. 8, a press molding operation (i.e., a stamping operation) may be performed on a plate-like hoop material. More specifically, the operation may be performed on a hoop material 50 which corresponds to one bus bar module 14 (see FIG. 4). A first intermediate forming product 52 is formed or stamped. The first intermediate forming product 52 may include a plurality of bus bars 22 in the developed state and a plurality of pieces of circuit wiring 54. The bus bars 22 and the pieces of circuit wiring 54 may be connected via tie bars (not shown) so that they may not be separated from each other. The pieces of circuit wiring 54 may be used as a signal line, a connection line, etc. Afterwards, they may be embedded in the resin portion 26a (see FIG. 4) of the circuit side member 24.

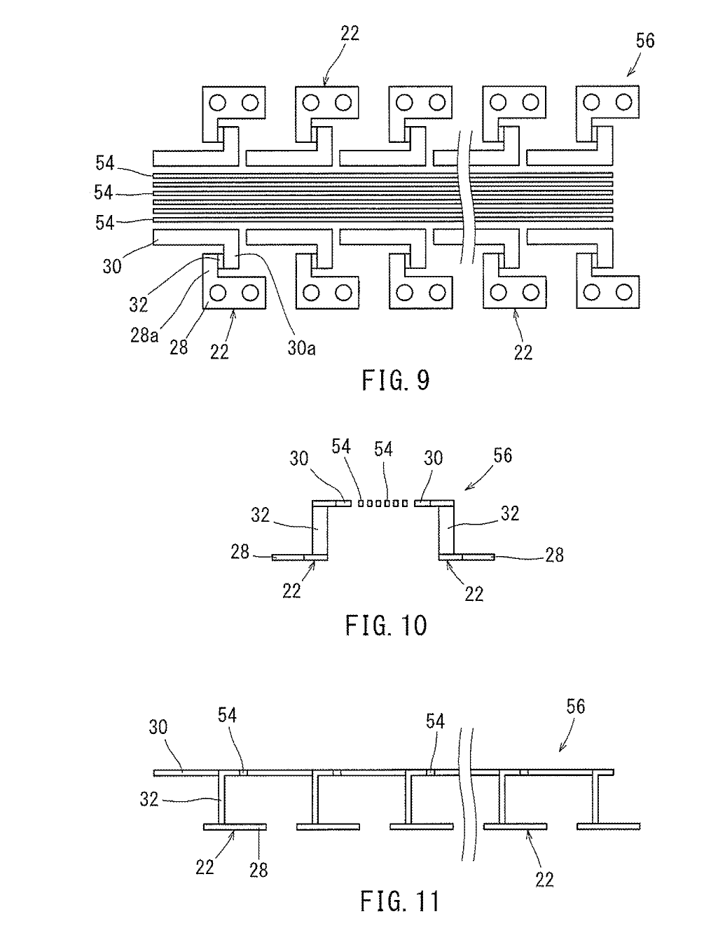

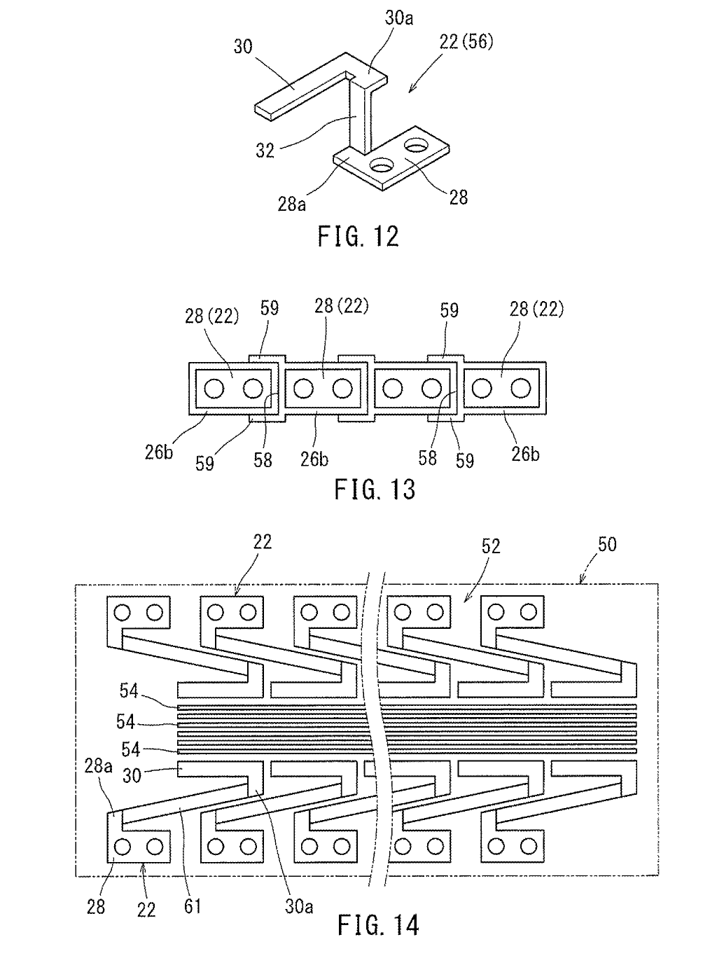

Next, a press molding operation, i.e., a bending operation, is performed on the first intermediate forming product 52 whereby a secondary intermediate forming product 56 may be formed (see FIGS. 9 through 11). The bus bars 22 of the secondary intermediate forming product 56 are shown in FIG. 12. Protrusions 28a from the battery side terminal portions 28 and the connection portions 32 may be formed at right angles to each other using a valley-folding process. The primary intermediate forming product 52 (see FIG. 8) is used in this process. The protrusions 30a and the connection portions 32 of the circuit side terminal portions 30 of the bus bars 22 may be formed at right angles to each other in a mountain-folding process (see FIG. 11).

After that, the electrical components 24a may be mounted on the circuit wiring 54 of the secondary intermediate forming product 56, and an insert molding process may be performed on the secondary intermediate forming product 56 whereby the resin member 26 is formed. Thereafter, the tie bars and unnecessary portions of the circuit wiring 54 may be cut off by a press working operation or the like whereby the bus bar module (more specifically, the main body thereof) 14 is completed. Finally, the gas discharge duct 35 separately formed may be connected with the bus bar module (more specifically, the main body thereof) 14, whereby the completed the bus bar module 14 equipped with the gas discharge duct 35 (see FIG. 1).

In the above-described bus bar module 14, each bus bar 22 has a battery side terminal portion 28 and a connection portion 32 formed as a single member. In this way, it is possible to achieve a reduction in the number of components and in the number of steps in assembling the bus bar 22. As a result, it is possible to achieve a reduction in the number of components and in the steps in assembling the bus bar module 14.

Further, due to the elastic deformation of the connection portions (i.e., the displacement absorption portions) 32 of the bus bars 22, it is possible to absorb the displacement of the battery side terminal portions 28 caused by the expansion and contraction in the arrangement direction of the battery assembly 12.

It is possible to absorb a change in dimensions in the arrangement direction of the battery assembly 12 caused by changes in temperature during use of the bus bar module 14 or due to charging/discharging. As a result, it is possible to prevent the circuit side member 24 from being affected by the dimensional changes in the arrangement direction of the battery assembly 12. Consequently, it is not necessary to form the circuit side member 24 such that it can expand or contract by taking into account the expansion or contraction in the arrangement direction (the longitudinal direction) of the battery assembly 12. Therefore, it is possible to achieve an improvement in terms of the degree of freedom in the design of the circuit side member 24. A reduction in the size of the circuit side member 24 can also be obtained. Further, it is possible to easily produce the circuit side member 24 in a fixed dimension.

Further, it is possible to absorb the dimensional difference in the arrangement direction of the battery assembly 12, which may be caused due to individual variation of the battery cells 16 of the battery assembly 12 at the time of assembly of the bus bar module 14.

Furthermore, the connection portions (displacement absorption portions) 32 of the bus bars 22 are formed in a strip-like form so as to be elastically deformable in the thickness direction (see the chain double-dashed lines in FIG. 3 showing potential deflections of connection portions 32). Thus, it is possible to suppress elastic deformation in a direction other than the thickness direction of the connection portions (displacement absorption portions) 32 while at the same time allowing for elastic deformation in the thickness direction of the connection portions (displacement absorption portions) 32.

Furthermore, the circuit side member 24 of the bus bar module 14 is integrally provided with the gas discharge duct 35 (See FIG. 1). Thus, by mounting the bus bar module 14 to the battery assembly 12, the gas discharge duct 35 is also mounted thereto. Accordingly, it is possible to improve the ease in assembling the gas discharge duct 35 and the battery assembly 12.

Furthermore, there is no need for the circuit side member 24 to be formed so as to be expandable and contractible in the front and rear directions. The circuit side member 24 undergoes no or little expansion/contraction in the front and rear directions, so that the gas discharge duct 35 may be integrated with the circuit side member 24.

Further, the gas discharge duct 35 is arranged on the lower surface side of the circuit side member 24 (see FIG. 1). Accordingly, the gas discharge duct 35 can be easily integrated with the circuit side member 24.

By forming the gas discharge duct 35 using a high-heat-capacity material, it is possible to quickly absorb the heat of the gas flowing inside. This can thereby make it possible to lower the temperature of the gas. Further, by forming the gas discharge duct 35 of a material with high heat conductivity, it is possible to prevent a local increase in the temperature of the gas discharge duct 35. Further, by forming the gas discharge duct 35 of a material with high heat insulation property such as a foam material, it is possible to achieve an improvement in terms of heat insulation, and to suppress the transfer of heat to the exterior of the duct.

Further, in the forming the bus bars 22, the disposable portion (waste portion) of the hoop material 50 (see FIG. 8) can be reduced. This can make it possible to effectively utilize the hoop material 50. Further, it may be possible to produce the bus bar module 14 by a progressive forming process. In this process, a number of machining processes are in turn performed on a strip-like hoop material 50 that is continuously fed.

Additional embodiments will now be described with reference to FIGS. 13 through 46. These embodiments include modifications of the embodiment of FIGS. 1-12. Therefore, the description will focus on the differences from the embodiment of FIGS. 1-12. In FIGS. 13 through 46, like members are given the same reference numerals as the embodiment of FIGS. 1-12, and redundant descriptions are omitted.

Another embodiment will now be described with reference to FIG. 13. As shown in FIG. 13, an engagement recess portion 58 is formed at one end portion (e.g., the front end portion (the left-hand end portion in FIG. 13)) of the resin portion 26b of the battery side terminal portion 28 of each bus bar 22. The engagement recess portion 58 has a pair of right and left restricting members 59. These restricting members 59 can engage the rear end portion of the resin portion 26b. Through mutual engagement between the rear end portion of the resin portion 26b and the engagement recess portion 58, it is possible to restrict the relative movement in the right and left direction (the up and down direction in FIG. 13) of the bus bars 22. Such potential movement may occur between the battery side terminal portions 28 and the resin portions 26b of the bus bars 22. As a result, it is possible to improve the ease in which the battery side terminal portions 28 of the bus bars 22 can be arranged with respect to the electrode terminals 18 of the battery cells 16 of the battery assembly 12 (see FIG. 1). In this way, the rear end portions of the resin portions 26b and the engagement recesses 58 may serve as restricting means.

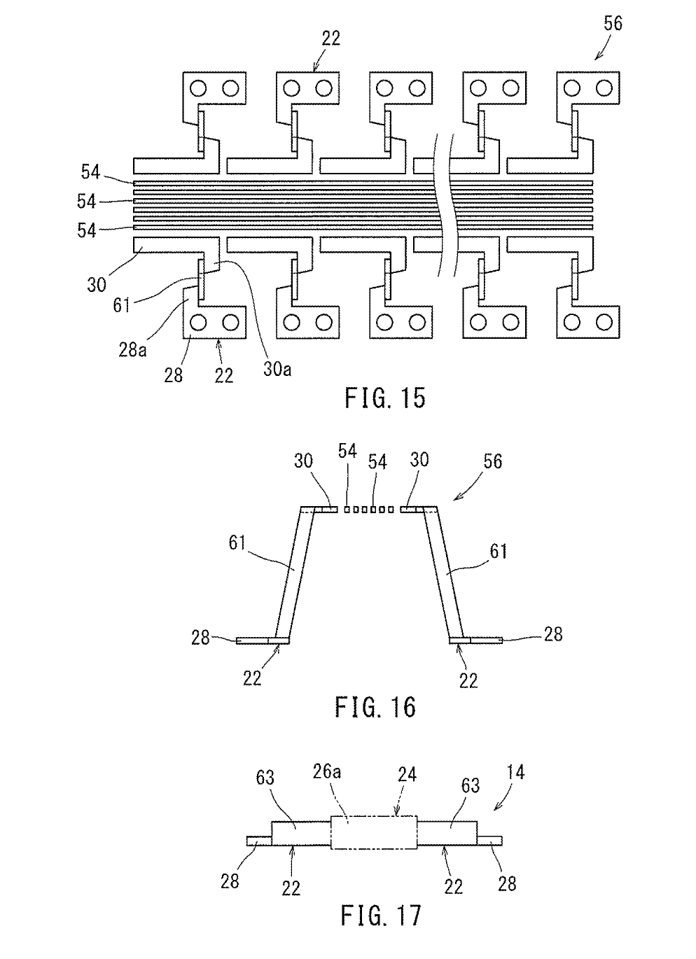

Another embodiment will now be described with reference to FIGS. 14 to 16. As shown in FIG. 14, the connection portions 32 (see FIG. 8) of the primary intermediate forming product 52 in the first embodiment are replaced with connection portions 61 that extend obliquely forwards and outwards. By bending the primary intermediate forming product 52 in the embodiment of FIGS. 1-12, the secondary intermediate forming product 56 (see FIGS. 15 and 16) can be formed.

In this embodiment, it is possible to form the connection portions 61 of the bus bars 22 in a longer and simpler configuration such that they don't interfere with the other members. As a result, it is possible to set the circuit side member 24 (see FIG. 1) of the bus bar module 14 at a higher position. Further, it is possible to increase the length of the displacement absorption portions configured as the connection portions 61.

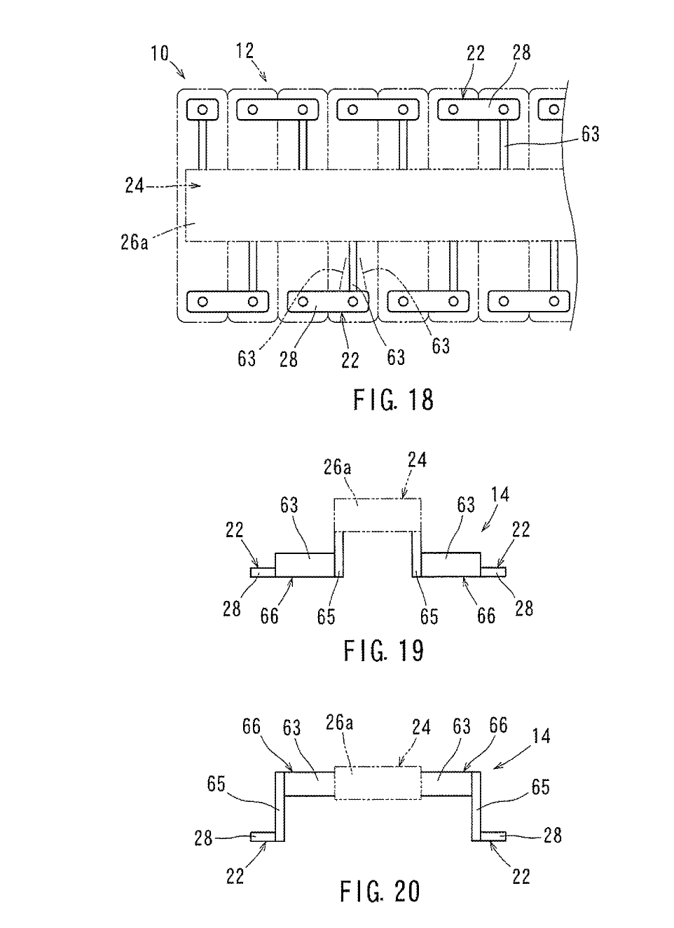

Another embodiment will now be described with reference to FIGS. 17 and 18. In FIGS. 17 and 18 (as well as for the embodiments of FIGS. 19-23), the resin member 26 covering the bus bars 22 is omitted for the purpose of illustration.

As shown in FIG. 17, the gas discharge duct 35 of the first embodiment (see FIG. 1) is omitted, and the circuit side member 24 is arranged to be at a lower position. In such a position, it is closer to the battery assembly 12. The connection portions (displacement absorption portions) (indicated by numeral 63) of the bus bars 22 are formed as strip-like plates extending in the right and left directions. The thickness direction of the connection portions (displacement absorption portions) 63 is oriented in the front and rear directions (the direction perpendicular to the sheet of FIG. 17). The connection portions (displacement absorption portions) 63 are formed so as to be capable of elastic deformation or so-called deflection deformation in the thickness direction, the front and rear directions (see the chain double-dashed lines in FIG. 18 showing potential deflections of connection portions 63).

Another embodiment will now be described with reference to FIG. 19. This embodiment is a modification of the embodiment of FIGS. 17 and 18. In this embodiment, support portions 65, having no or little function in absorbing the displacement in the arrangement direction of the battery assembly 12, are formed between the connection portions (displacement absorption portions) 63 of the bus bars 22 in the embodiment of FIGS. 17 and 18. That is, the connection portions (indicated by numeral 66) have displacement absorption portions 63 and support portions 65. The support portions 65 are formed as strip-like plates extending in the height direction. The thickness direction of the support portions 65 is oriented in the right and left directions. Further, as in the first embodiment (see FIG. 1), it is possible to arrange the gas discharge duct 35 between the two support portions 65.

Another embodiment will now be described with reference to FIG. 20. The present embodiment is different from the embodiment of FIG. 19 in that the arrangement of the displacement absorption portions 63 and the support portions 65 in the connection portions 66 of the bus bars 22 is altered (see FIG. 19). That is, the support portions 65 are arranged on side of the battery side terminal portion 28 and the displacement absorption portions 63 are arranged on the side of the circuit side terminal portion 30.

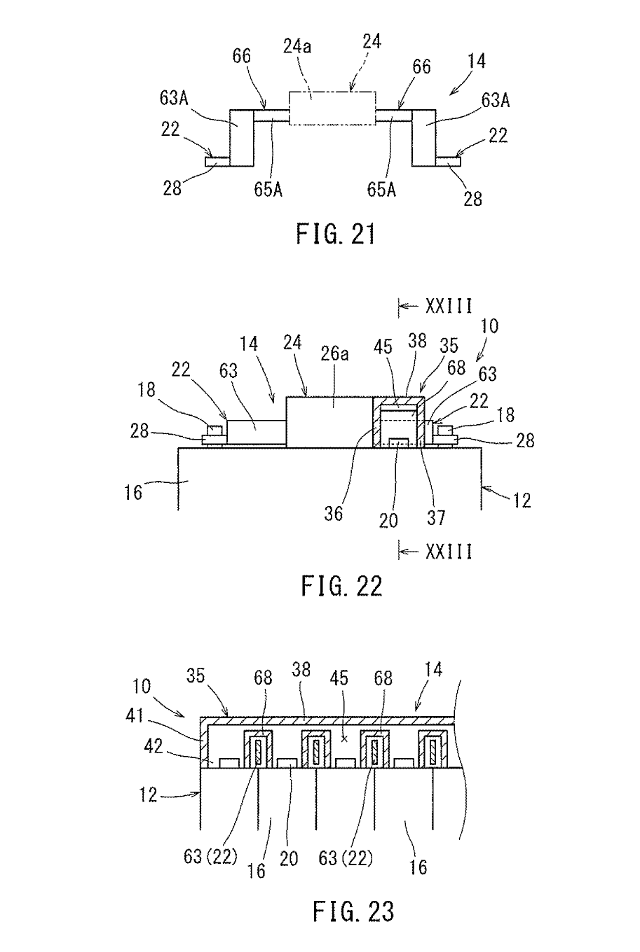

Another embodiment will now be described with reference to FIG. 21. In this embodiment, the displacement absorption portions 63 of the connection portions 66 of the bus bars 22 of the embodiment of FIG. 19 are replaced with displacement absorption portions (indicated by numeral 63A) extending in the height direction. The thickness direction of the displacement absorption portions 63A is oriented in the front and rear directions (the direction perpendicular to the sheet of FIG. 21). Further, the support portions 65 of the connection portions 66 of the bus bars 22 of the embodiment of FIG. 19 are replaced with connection portions (indicated by numeral 65A) that extend in the right and left directions. The thickness direction of the support portions 65A is oriented in the up and down direction.

Another embodiment 8 will now be described with reference to FIGS. 22 and 23. This embodiment is a modification of the embodiment of FIGS. 17 and 18. In FIG. 22, the gas discharge duct 35 is shown in a vertical sectional view.

As shown in FIG. 22, the left-hand side wall 36 of the gas discharge duct 35 is integrally connected with one side (e.g., the right-hand side) of the circuit side member 24 of the embodiment of FIGS. 17 and 18. This arrangement is similar to that in the embodiment of FIGS. 1-12.

As shown in FIG. 23, in the gas discharge duct 35, there are formed partition wall portions 68 that respectively straddle the connection portions (displacement absorption portions) 63. The partition wall portions 68 are formed in an inverted U-shaped sectional configuration and extend between the left-hand side wall 36 and the right-hand side wall 37 (See FIG. 22). The safety valves 20 of the battery cells 16 are arranged at positions moved to the right as compared to their positions in the embodiment of FIGS. 1-12. Here they correspond to the gas introduction port 43 of the gas discharge duct 35.

In the present embodiment, the circuit side member 24 and the gas discharge duct 35 are arranged in parallel in the right and left direction whereby it is possible to reduce the height of the bus bar module 14. Two gas discharge ducts 35 may be arranged symmetrically on the right and left sides with the circuit side member 24 positioned therebetween.

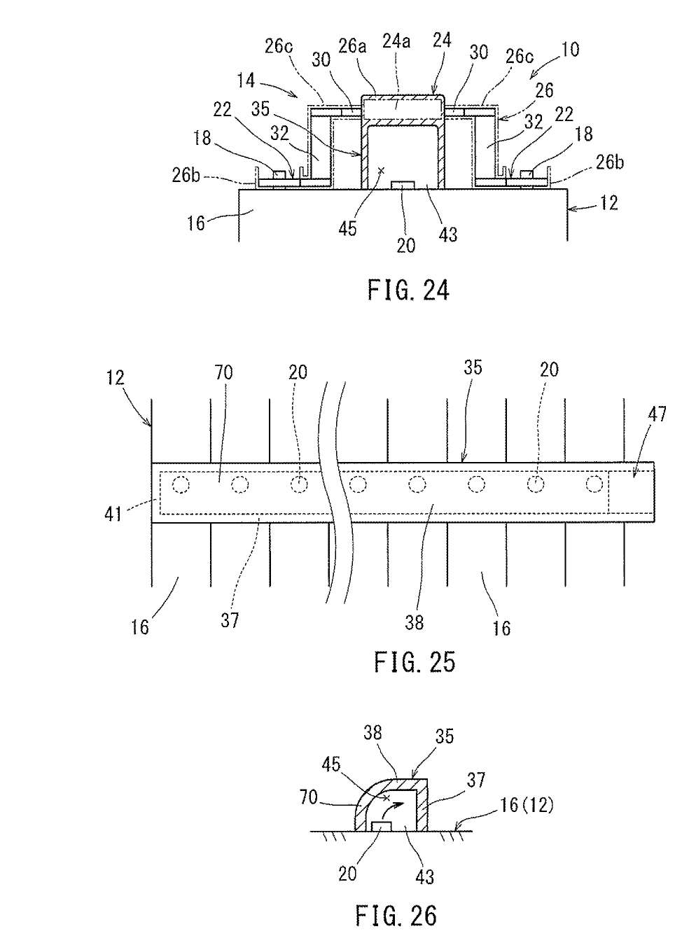

Another embodiment will now be described with reference to FIG. 24. This embodiment is different from the embodiment of FIGS. 1-12 in that the resin portion 26a and the gas discharge duct 35 are formed integrally with each other by a two-color (two different resin materials) molding process. Thus, it is possible to eliminate the step for assembling the gas discharge duct 35 with the bus bar module 14. Further, it is also possible to integrally form the gas discharge duct 35 and the resin portion 26a of the circuit side member 24. The same resin material can be used for the resin portion 26a of the circuit side member 24 and for the gas discharge duct 35.

Another embodiment 10 will be described with reference to FIGS. 25 and 26. The present embodiment is different from the embodiment of FIGS. 1-12 in that the width in the right and left direction of the gas discharge duct 35 is enlarged toward one side (e.g., to the right). Instead of the left-hand side wall 36 (see FIG. 1) of the gas discharge duct 35, there is formed a guide wall portion 70 of an arcuate sectional configuration. The guide wall portion 70 is formed such that it opposes the safety valves 20 of the battery cells 16 of the battery assembly 12 (see FIGS. 25 and 26).

According to the present embodiment, the gas discharged (ejected) from the safety valves 20 of the battery cells 16 of the battery assembly 12 may collide with the guide wall portion 70 of the gas discharge duct 35. In this embodiment, the direction of the gas flow may be to the right (see the arrow in FIG. 26). Therefore, it is possible to suppress the thermal influence of the gas on the circuit side member 24. Hence, it is possible to reduce the height of the gas discharge duct 35. In this way, the guide wall portion 70 may serve as a “flow direction changing member.” The guide wall portion 70 may be formed to have a straight cross-sectional shape.

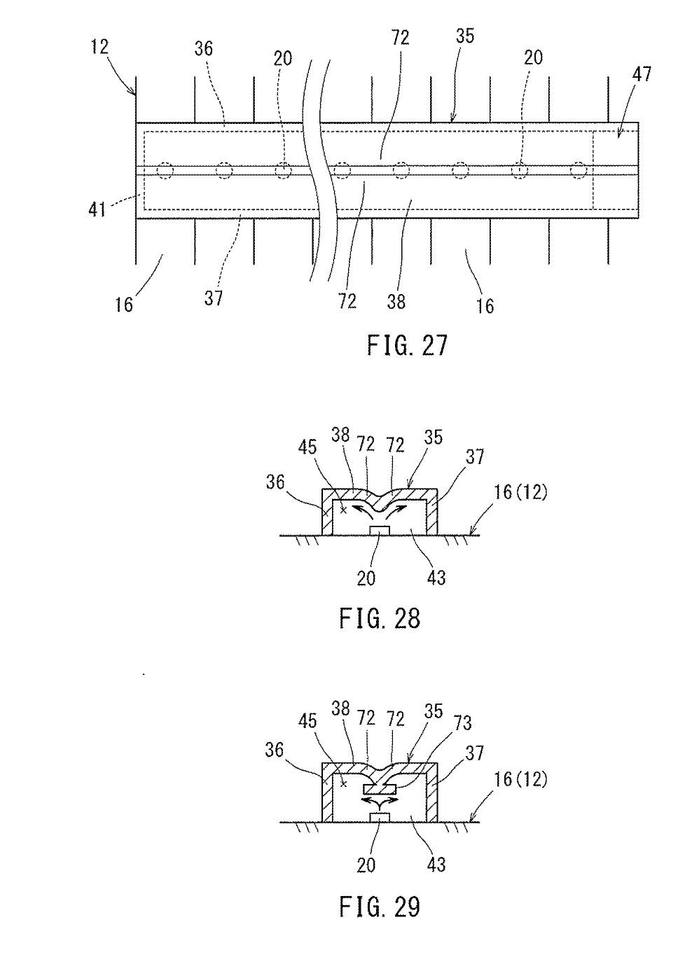

Another embodiment will now be described with reference to FIGS. 27 and 28. The present embodiment is a modification of the embodiment of FIGS. 1-12. As shown in FIG. 28, the gas discharge duct 35 is expanded in the left and right directions. At the center, in the right and left directions of the upper wall 28 of the gas discharge duct 35, there are formed right and left guide wall portions 72 each having an arcuate sectional configuration. They are arranged to be symmetrical with each other in the right and left directions, so as to exhibit a V-shaped sectional configuration. Both guide wall portions 72 face the safety valves 20 of the battery cells 16 of the battery assembly 12 (see FIGS. 27 and 28).

According to this embodiment, the gas discharged (ejected) from the safety valves 20 may reach both guide wall portions 72 of the gas discharge duct 35. It is here that the gas flow moves in a lateral direction (see the arrows in FIG. 28). In this way, it is possible to suppress the thermal influence of the gas on the circuit side member 24. Hence, it is possible to reduce the height of the gas discharge duct 35. In this way, the guide wall portions 72 may serve as “flow direction changing members.”

Another embodiment will now be described with reference to FIG. 29. The present embodiment is a modification of the embodiment of FIGS. 27 and 28. As shown in FIG. 29, a horizontal collision wall portion 73 is provided at the lower end portions of the guide wall portions 72 of the gas discharge duct 35 of the embodiment of FIGS. 27 and 28 (see specifically FIG. 28). The collision wall portion 73 faces the safety valves 20 of the battery cells 16 of the battery assembly 12.

According to the present embodiment, the gas discharged (ejected) from the safety valves 20 may reach with the collision wall portion 73 of the gas discharge duct 35. It is here that the gas flow moves in a generally lateral direction (see the arrows in FIG. 29). In this way, the collision wall portion 73 may serve as a “flow direction changing member.”

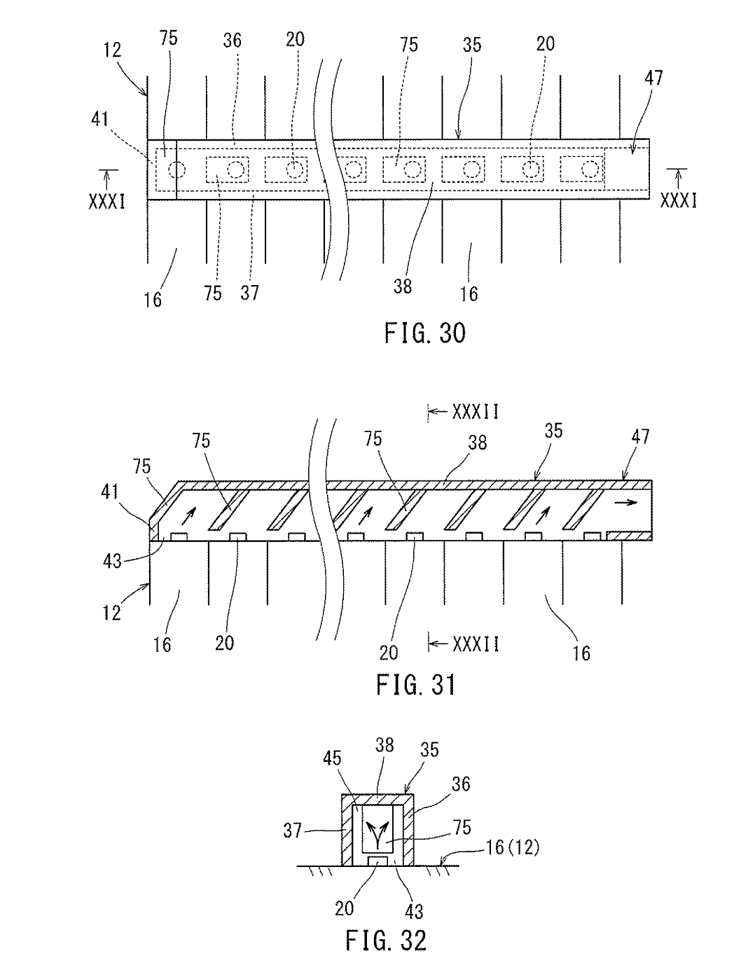

Another embodiment will now be described with reference to FIGS. 30, 31 and 32. The present embodiment is a modification of the embodiment of FIGS. 1-12. As shown in FIG. 32, in the present embodiment, a plurality of guide wall portions 75 arranged in the front and rear directions are formed on the lower surface of the central portion in the width direction of the upper wall 38 of the gas discharge duct 35 of the embodiment of FIGS. 1-12 (see specifically FIG. 7). The guide wall portions 75 are protruding members protruding obliquely downwards and forwards (see FIG. 31). The remaining portions, except for the lower end portion of the front wall 41 of the gas discharge duct 35, are also formed as the guide wall portions 75 (see FIG. 30). The guide wall portions 75 face the safety valves 20 of the battery cells 16 of the battery assembly 12 (see FIGS. 30 through 32). The lower surface of the upper wall 38 of the discharge duct 35 serves as a “circuit side member side inner wall surface.”

In the present embodiment, the gas discharged (ejected) from the safety valves 20 of the battery cells 16 of the battery assembly 12 may reach the guide wall portion 75 of the gas discharge duct 35, whereby the direction of the gas flow changes (see arrows in FIGS. 31 and 32). Thus, the gas discharged (ejected) from the safety valves 20 of the battery cells 16 may not directly reach with the upper wall 38 of the gas discharge duct 35. In this way, it is possible to suppress the thermal influence of the gas on the circuit side member 24 making it possible to improve the reliability of the circuit side member 24. Hence, it is possible to reduce the height of the gas discharge duct 35, and to reduce the path sectional area. In this way, the guide wall portions 75 may serve as “flow direction changing members.”

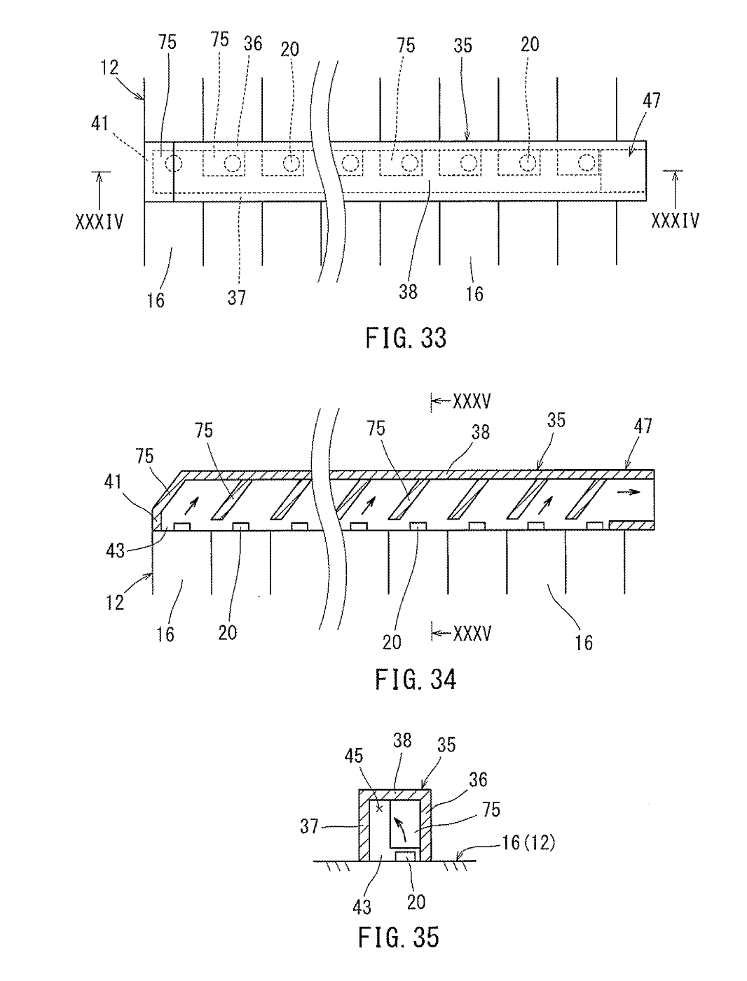

Another embodiment 14 will now be described with reference to FIGS. 33, 34 and 35. The present embodiment is a modification of the embodiment of FIGS. 30, 31 and 32. As shown in FIG. 35, the guide wall portions 75 of the gas discharge duct 35 of the thirteenth embodiment (see FIG. 32) are moved to one side (e.g., to the left-hand side) of the upper wall 38 so as to be continuous with the left-hand side wall 36. In this connection, the gas discharge duct 35 is arranged so as to be moved to the right so that the gas discharged (ejected) from the safety valves 20 of the battery cells 16 of the battery assembly 12 may respectively reach the guide wall portions 75 (see FIG. 33).

According to the present embodiment, the gas discharged (ejected) from the safety valves 20 of the battery cells 16 of the battery assembly 12 respectively reaches the guide wall portions 75 of the gas discharge duct 35, whereby the direction of the gas flow changes (see arrows in FIGS. 34 and 35).

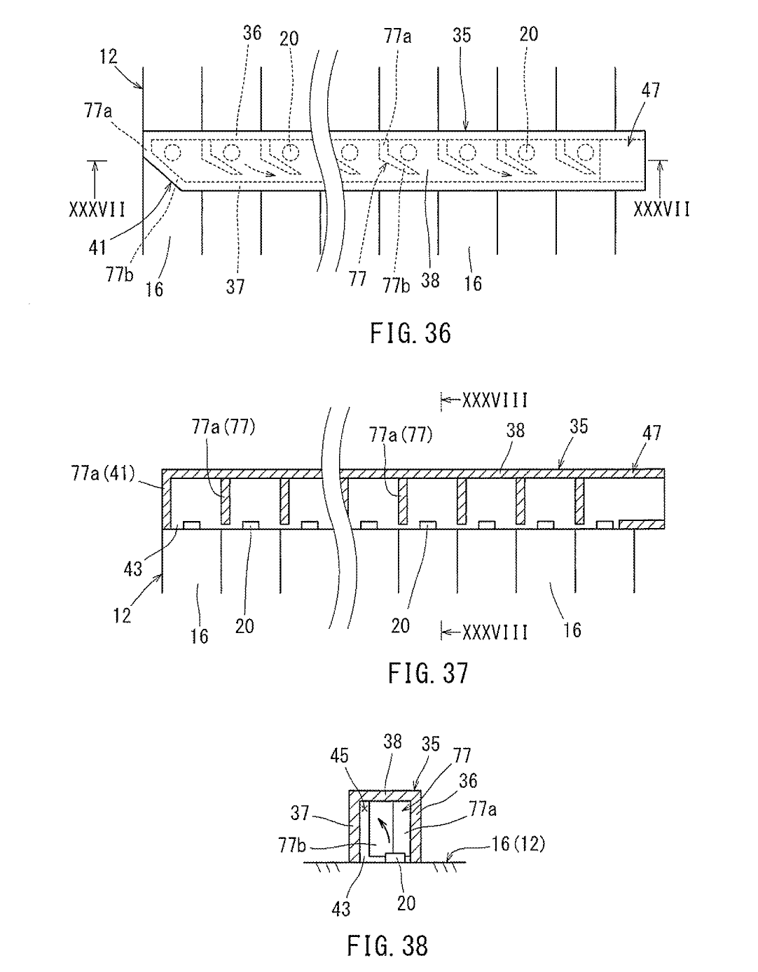

Another embodiment will be described with reference to FIGS. 36, 37 and 38. The present embodiment is a modification of the embodiment of FIGS. 1-12. As shown in FIG. 38, the gas discharge duct 35 of the embodiment of FIGS. 1-12 (see specifically FIG. 7) is enlarged toward one side (e.g., to the right (to the left in FIG. 38)). On the lower surface of the left portion (the right portion in FIG. 38) of the upper wall 38 of the gas discharge duct 35, there is formed a plurality of guide wall portions 77 arranged in the front and rear directions. The guide wall portions 77 are continuous with the left-hand side wall 36. Each of the guide wall portions 77 has a flat-plate-like flat wall portion 77a and an inclined wall portion 77b. The flat wall portion 77a is situated between two adjacent safety valves 20 of the battery assembly 12 (see FIG. 37). The inclined wall portion 77b protrudes obliquely backwards to the right from the right-hand end portion of the flat wall portion 77a (see FIG. 36). Further, at the front wall 41 of the gas discharge duct 35, there is also formed a flat wall portion 77a and an inclined wall portion 77b like the guide wall portions 77.

According to the present embodiment, the flow direction of the gas discharged (ejected) from the safety valves 20 of the battery cells 16 of the battery assembly 12 is altered by the guide wall portions 77 (see arrows in FIGS. 36 and 38). Further, due to the guide wall portions 77, the left half of the gas path 45 is defined as an independent path (see FIG. 37). As a result, it is possible to extend the path length of the gas path 45. In this way, the guide wall portions 77 serve as “flow direction changing members.” A portion of the gas path 45 extending from the safety valve 20 and not divided by the guide wall portions 77 will be referred to as a common path.

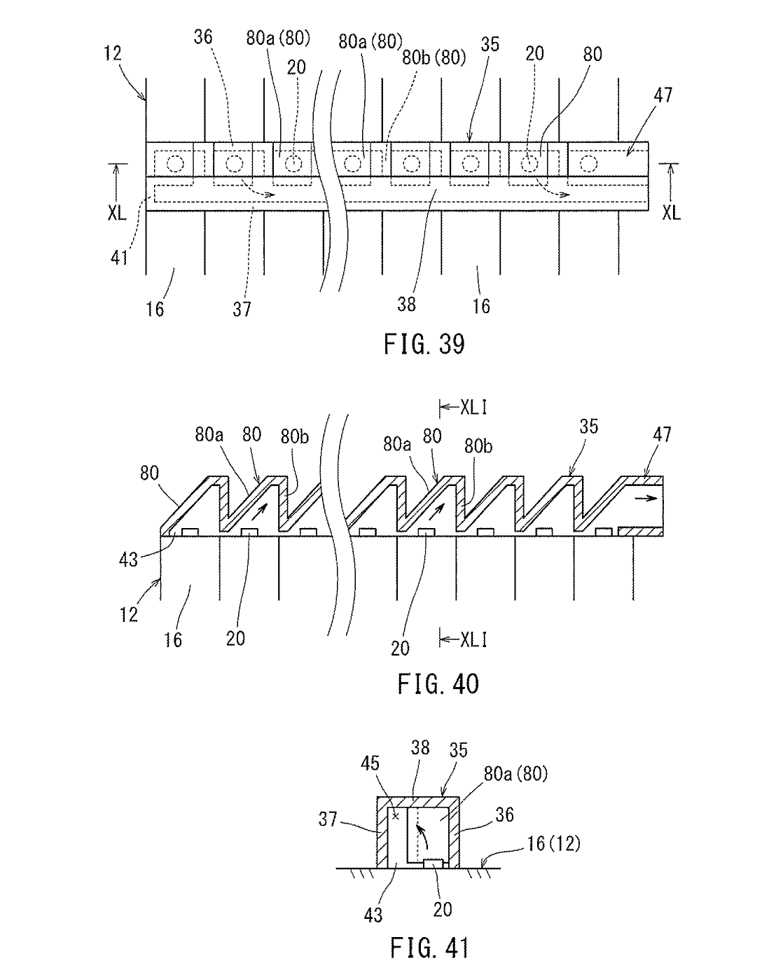

Another embodiment will now be described with reference to FIGS. 39, 40 and 41. The present embodiment is a modification of the embodiment of FIGS. 1-12. As shown in FIG. 39, a plurality of guide wall portions 80 are formed in the left half portion (including the left half portion of the front wall 41) of the upper wall 38 of the gas discharge duct 35 of the embodiment of FIGS. 1-12 (see specifically FIG. 6) so as to be continuous therewith in the front and rear directions in a saw-teeth-like fashion (see FIG. 40). The guide wall portions 80 are formed to have an inverted V-shaped sectional configuration. Each of the guide wall portions 80 includes an inclined wall portion 80a and a flat wall portion 80b extending vertically from the rear end of the inclined wall portion 80a. The inclined wall portions 80a are positioned so as to respectively correspond to the safety valves 20 of the battery cells 16 of the battery assembly 12 (see FIGS. 39 through 41).

According to the present embodiment, the gas discharged (ejected) from the safety valves 20 of the battery cells 16 of the battery assembly 12 may reach the inclined wall portions 80a of the guide wall portions 80 of the gas discharge duct 35, whereby the direction of the gas flow changes (see arrows in FIGS. 39 and 40). Thus, the gas discharged (ejected) from the safety valves 20 of the battery cells 16 does not directly reach the upper wall 38 of the gas discharge duct 35. In this way, it is possible to suppress the thermal influence of the gas on the circuit side member 24 making it possible to improve the operability of the circuit side member 24. It is also possible to reduce the height of the gas discharge duct 35 and reduce the path sectional area. In this way, the guide wall portions 80 serve as “flow direction changing members.”

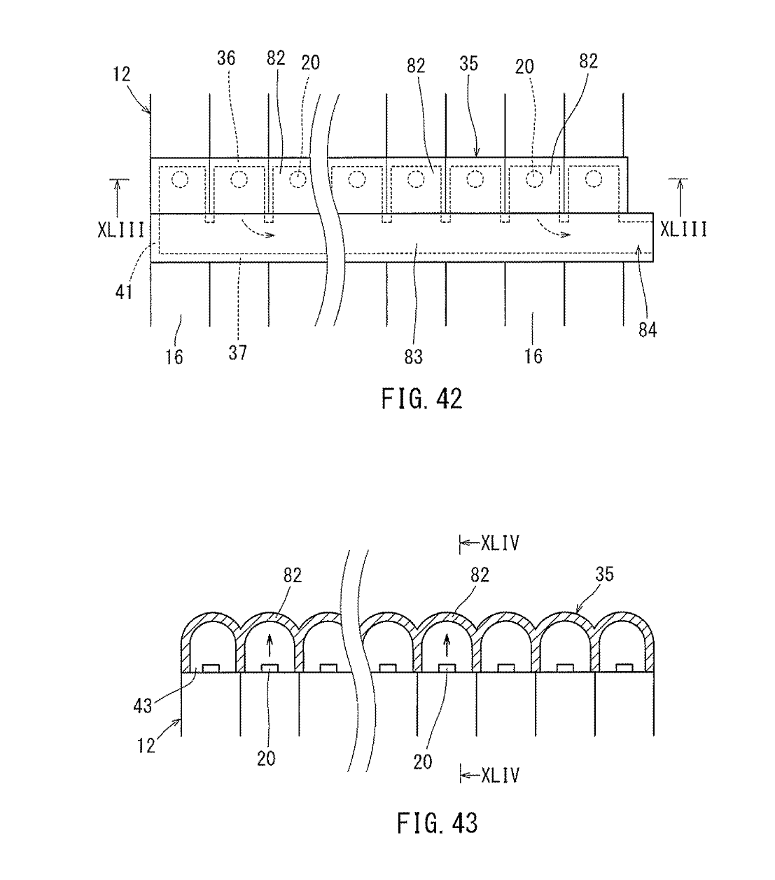

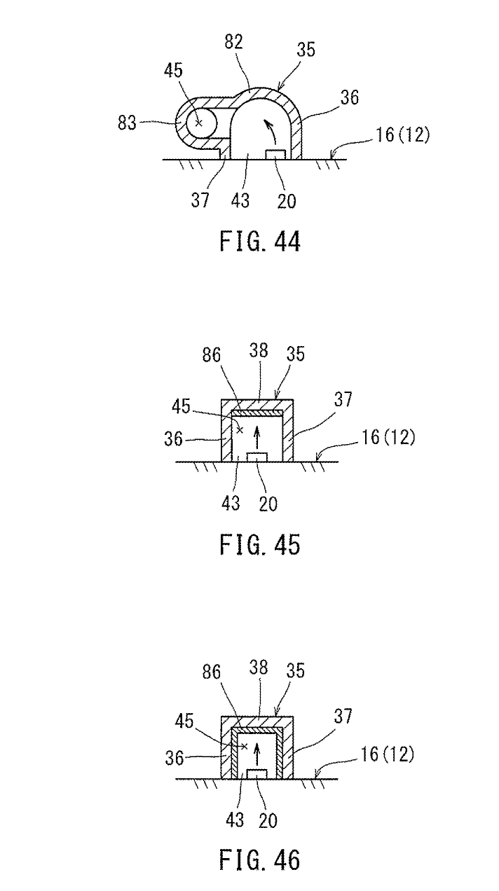

Another embodiment will now be described with reference to FIGS. 42, 43 and 44. The present embodiment is a modification of the embodiment of FIGS. 39, 40 and 41. As shown in FIG. 43, the guide wall portions 80 of the gas discharge duct 35 of the embodiment of FIGS. 39, 40 and 41 (see specifically FIG. 40) are changed to semi-circular guide wall portions 82 having peaks at their central portions. On the right-hand side portion of the gas discharge duct 35, there is formed a tubular wall portion 83 which is of a C-shaped sectional configuration. The opening of the C-shape communicates with the spaces in the guide wall portions 82 (see FIG. 44). In this connection, the connection port 47 (see FIG. 39) is replaced with a cylindrical connection port 84 (see FIG. 42). The interior of the cylindrical wall portion 83 (inclusive of the connection port 43) defies the gas path 45 (see FIG. 44). The guide wall portions 82 serve as “flow direction changing members.”

Another embodiment will now be described with reference to FIG. 45. The present embodiment is a modification of the embodiment of FIGS. 1-12. As shown in FIG. 45, a lining member 86 exhibiting heat shielding and/or heat absorption is provided on the ceiling surface (the lower surface of the upper wall 38) of the gas path 45 of the gas discharge duct 35 of the embodiment of FIGS. 1-12 (see specifically FIGS. 5 through 7).

According to the present embodiment, if the lining member 86 is chosen to exhibit heat absorption performance, the heat of the high-temperature gas ejected from the safety valves 20 of the battery cells 16 of the battery assembly 12 may be absorbed by the lining member 86 and may be diffused in the longitudinal direction (the direction perpendicular to the sheet of FIG. 45). In this way, it is possible to prevent transfer of heat to the gas discharge duct 35 and lower the temperature of the gas discharge duct 35. It is possible to employ a metal material of large heat capacity as the heat absorbing material of the lining member 86.

If the lining member 86 is chosen to exhibit heat shielding performance, the heat of the high-temperature gas ejected from the safety valves 20 of the battery cells 16 of the battery assembly 12 undergoes heat shielding (inclusive of heat insulation). In this way, it is possible to prevent the transfer of heat to the gas discharge duct 35. It is possible to employ a foam material or a ceramic material as the heat shielding material of the lining member 86.

Another embodiment will be described with reference to FIG. 46. The present embodiment is a modification of the embodiment of FIG. 45. As shown in FIG. 46, the lining member 86 of the embodiment of FIG. 45 is provided on the ceiling surface (the lower surface of the upper wall 38) and also on both wall surfaces (both inner wall surfaces of the left-hand side wall 36 and the right-hand side wall 37) of the gas path 45 of the gas discharge duct 35.

Each of the above-described embodiments may be further modified in various ways. For example, the bus bar module 14 may be applicable not only to a hybrid car but also to other vehicles such as an electric automobile; further, it is also applicable to a battery module for other uses than vehicles. Further, if the terminals of the circuit side member 24 protrude from the resin portion 26a, it is also possible to omit the circuit side terminal portions 30 of the bus bars 22 and the connect connection portions to the terminals of the circuit side member 24.

Representative, non-limiting examples have been described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bus bar modules, and methods of making and using the same.

Moreover, combinations of features and steps disclosed in the above detailed description may not be necessary to practice the invention in the broadest sense, and are instead taught merely to particularly describe representative examples. Furthermore, various features of the above-described representative examples, as well as the various independent and dependent claims below, may be combined in ways that are not specifically and explicitly enumerated in order to provide additional useful embodiments.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bus bar module comprising:
a circuit side member associated with a battery assembly having a plurality of battery cells arranged next to each other in an arrangement direction;
a bus bar having a battery side terminal portion and a connection portion, the battery side terminal portion electrically connecting electrode terminals of two adjacent battery cells of the battery assembly, the connection portion electrically connecting the battery side terminal portion and a terminal of the circuit side member; and
a resin member for insulating the bus bar;
wherein the bus bar is configured as a single member; and
wherein the connection portion of the bus bar is formed with a displacement absorbing portion capable of absorbing displacement of the battery side terminal portion caused by expansion or contraction in the arrangement direction of the battery assembly.

2. The bus bar module according to claim 1, wherein the displacement absorbing portion of the bus bar has a strip shape and is elastically deformable in a thickness direction thereof.

3. The bus bar module according to claim 1, wherein:
the bus bar module comprises a plurality of bus bars;
the resin member has a plurality of resin portions respectively covering the battery side terminal portions of the bus bars, and
a restriction device is provided between two adjacent resin portions and configured to restrict relative movement of the battery assembly in a width direction.

4. The bus bar module according to claim 1, further comprising a gas discharge duct communicating with safety valves of the battery cells, so that gas produced in the battery cells flows into the gas discharge duct via the safety valves and is discharged to an outside.

5. The bus bar module according to claim 4, wherein the gas discharge duct is fixedly joined to the circuit side member.

6. The bus bar module according to claim 4, further comprising a flow direction changing device configured to change the direction of flow of gas ejected from the safety valves in order to reduce the influence of heat of the gas on the circuit side member.

7. The bus bar module according to claim 1, wherein the bus bar further includes a circuit side terminal portion electrically connectable to the terminal of the circuit side member, and the connection portion connecting the battery side terminal portion and the circuit side terminal portion.

8. The bus bar module according to claim 7, wherein the circuit side terminal portion, the connection portion and the battery side terminal portion are configured as flat plates having a same thickness.

9. The bus bar module according to claim 8, wherein the connecting portion extends substantially perpendicular to both the circuit side terminal portion and the battery side terminal portion.

10. A bus bar module comprising:
a circuit side member associated with a battery assembly having a plurality of battery cells arranged next to each other in an arrangement direction; and
a bus bar having a battery side terminal portion and a connection portion, the battery side terminal portion electrically connecting electrode terminals of two adjacent battery cells of the battery assembly, the connection portion electrically connecting the battery side terminal portion and a terminal of the circuit side member;
wherein the bas bar is a single member with the battery side terminal portion and the connection portion integrated with each other.

11. A bus bar module comprising:
a circuit side member associated with a battery assembly having a plurality of battery cells arranged next to each other in an arrangement direction; and
a bus bar having a battery side terminal portion and a connection portion connected to each other, the battery side terminal portion electrically connecting electrode terminals of two adjacent battery cells of the battery assembly, the connection portion electrically connecting the battery side terminal portion and a terminal of the circuit side member;
wherein the connection portion of the bus bar is formed with a displacement absorbing portion capable of absorbing displacement of the battery side terminal portion caused by expansion or contraction in the arrangement direction of the battery assembly.
